(19) United States
(12) Patent Application Publication
(10) Pub. No.: US 2007/0211194 A1
(43) Pub. Date: Sep. 13, 2007

(54) METHOD OF MANUFACTURING COLOR FILTER ARRAY PANEL AND LIQUID CRYSTAL DISPLAY

(75) Inventor: Sung-Hwan Cho, Hwasung-gun (KR)

Correspondence Address: MACPHERSON KWOK CHEN & HEID LLP, 2033 GATEWAY PLACE, SUITE 400, SAN JOSE, CA, 95110, US

(73) Assignee: SAMSUNG ELECTRONICS CO., LTD., Suwon-si (KR)

(21) Appl. No.: 11/538,337

(22) Filed: Oct. 3, 2006

(30) Foreign Application Priority Data
Mar. 10, 2006 (KR) 10-2006-0022586

(51) Int. Cl. G02F 1/1335

(52) U.S. Cl. 349/106

(57) ABSTRACT

A color filter array panel includes forming a first photosensitive film having a first amount of pigment on an insulation substrate, forming on the first photosensitive film a second photosensitive film having a second amount of pigment, greater than the first amount of pigment, and exposing and developing the first and second photosensitive films to form a first color filter and a second color filter exposing a predetermined region of the first color filter.

### CROSS-REFERENCE TO RELATED APPLICATION

This application claims priority to and the benefit of Korean Patent Application No. 10-2006-0022586 filed in the Korean Intellectual Property Office on Mar. 10, 2006, the entire contents of which are incorporated herein by reference.

### BACKGROUND OF THE INVENTION

(a) Field of the Invention

The present invention relates to a liquid crystal display, and more particularly, to a transflective liquid crystal display.

(b) Description of Related Art

A liquid crystal display is now widely used as a type of flat panel display. The liquid crystal display includes two display panels on which field generating electrodes, such as pixel electrodes and a common electrode, are formed, and a liquid crystal layer interposed therebetween. When a voltage is applied to the field generating electrodes so as to generate an electric field, the orientation of liquid crystal molecules is determined, and the polarization of incident light is controlled to display images.

Examples of liquid crystal display include a transmissive liquid crystal display, a reflective liquid crystal display, and a transflective liquid crystal display, depending on the type of a light source. The transmissive liquid crystal display displays images by means of a lighting unit provided on the rear surface of the liquid crystal cell, and the reflective liquid crystal display displays images by means of natural light from the outside. Furthermore, the transflective liquid crystal display has a structure in which the transmissive liquid crystal display and the reflective liquid crystal display are combined with each other. The transflective liquid crystal display operates in two modes including a transmissive mode and a reflective mode. In the transmissive mode, the transflective liquid crystal display displays images by means of a light source integrated into the display element in a dark place where an interior or external light source is not provided. In the reflective mode, the transflective liquid crystal display displays images through the reflection of external light in a bright place, such as outdoors.

The transflective liquid crystal display has a difference in color reproducibility due to the difference between the optical paths of a transmissive portion and a reflective portion. For this reason, a method of using color filters that have light holes or different purities has been proposed to compensate for the difference in color reproducibility.

The above information disclosed in this Background section is only for enhancement of understanding of the background of the invention and therefore it may contain information that does not form the prior art that is already known in this country to a person of ordinary skill in the art.

### SUMMARY OF THE INVENTION

According to the method of using the color filters that have different purities, the color filters having different purities are formed in the transmissive portion and the reflective portion. Accordingly, when forming a red color filter, a green color filter, and a blue color filter, it is necessary to perform a photolithography process a total of six times.

Therefore, the present invention has been made in an effort to provide a method of manufacturing a color filter array panel that has advantages of reducing the number of photolithography processes and forming color filters having different purities in a transmissive portion and a reflective portion.

A method of manufacturing a color filter array panel according to an exemplary embodiment of the present invention includes forming a first photosensitive film having pigment on an insulation substrate, forming a second photosensitive film having a larger amount of pigment than that of the first photosensitive film on the first photosensitive film, and exposing and developing the first and second photosensitive films to form a first color filter and a second color filter exposing a predetermined region of the first color filter.

The first and second photosensitive films may be simultaneously exposed using a photomask that includes three portions A, B, and C having different light transmittances in the exposing of the first and second photosensitive films.

The photomask may include a light transmissive area, a light blocking area, and a translucent area, and the translucent area may include a thin film having a slit pattern, a lattice pattern, or intermediate transmittance or intermediate thickness.

A liquid crystal display according to another exemplary embodiment of the present invention includes a first substrate; pixel electrodes that are formed on the first substrate and each of which has a reflecting electrode and a transparent electrode; a second substrate that faces the first substrate; a first color filter that is formed on the second substrate; a second color filter that is partially formed on a predetermined region of the first color filter; a common electrode that is formed on the first and second color filters and faces the pixel electrodes; and a liquid crystal layer that is interposed between the common electrode and the pixel electrodes.

The first color filter may be disposed at a position corresponding to the reflecting electrode and the transparent electrode, and the second color filter may be disposed at a position corresponding to the transparent electrode.

The second color filter may contain a larger amount of pigment than the first color filter.

The liquid crystal display may further include an overcoat that is formed between the first and second color filters and the common electrode.

### BRIEF DESCRIPTION OF THE DRAWINGS

FIG. 1 is a layout view of a liquid crystal display according to an exemplary embodiment of the present invention.

FIG. 2 is a cross-sectional view of the liquid crystal display, which is taken along the line II-II′ of FIG. 1, and FIG. 3 is a cross-sectional view of the liquid crystal display, which is taken along the line III-III′ of FIG. 1.

FIGS. 4 to 7 are cross-sectional views illustrating a method of manufacturing a color filter array panel according to an exemplary embodiment of the present invention.

### DETAILED DESCRIPTION OF EMBODIMENTS

The present invention will be described more fully hereinafter with reference to the accompanying drawings, in which preferred embodiments of the invention are shown. As those skilled in the art would realize, the described embodiments may be modified in various different ways, all without departing from the spirit or scope of the present invention.

In the drawings, the thickness of layers, films, panels, regions, etc., may be exaggerated for clarity. Like reference numerals designate like elements throughout the specification. It will be understood that when an element such as a layer, film, region or substrate is referred to as being “on” another element, it can be directly on the other element or intervening elements may also be present. In contrast, when an element is referred to as being “directly on” another element, there are no intervening elements present.

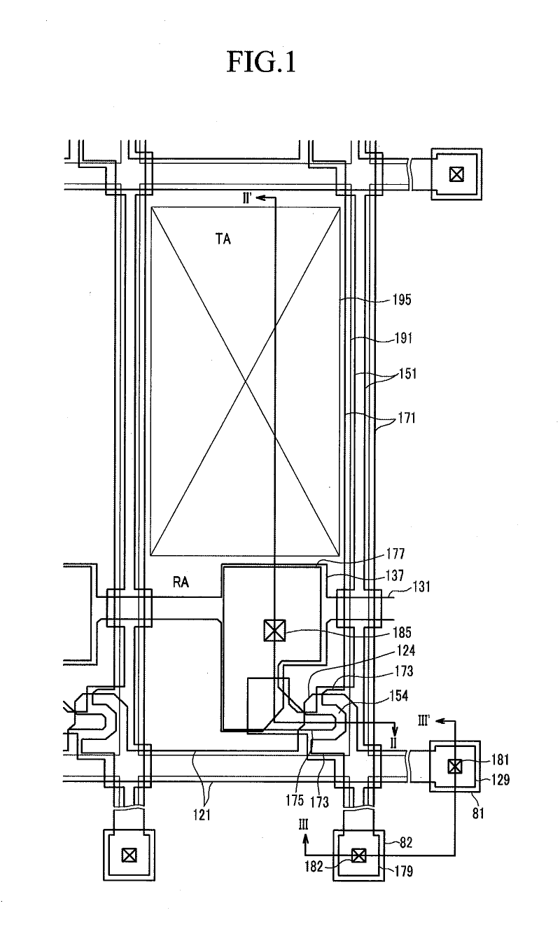

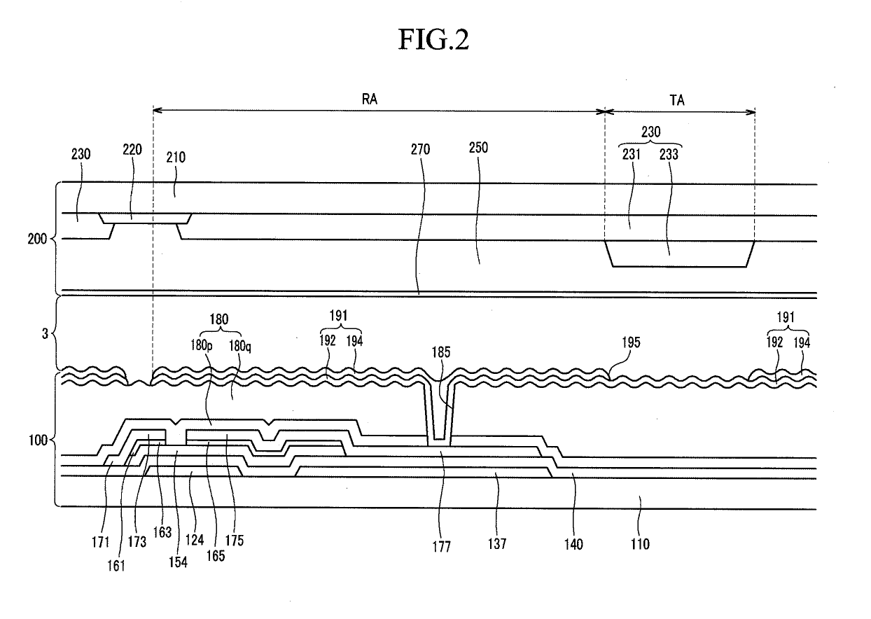

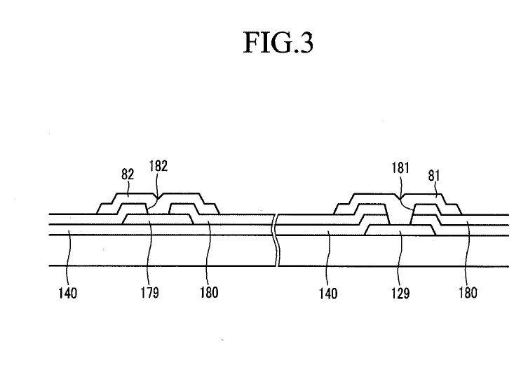

First, a liquid crystal display according to an exemplary embodiment of the present invention will be described in detail with reference to FIGS. 1 to 3. FIG. 1 is a layout view of a liquid crystal display according to an exemplary embodiment of the present invention. FIG. 2 is a cross-sectional view of the liquid crystal display of FIG. 1 taken along the line II-II′. FIG. 3 is a cross-sectional view of the liquid crystal display of FIG. 1 taken along the line III-III′.

A liquid crystal display according to a present exemplary embodiment includes a thin film transistor array panel 100, a common electrode panel 200 facing the thin film transistor array panel 100, and a liquid crystal layer 3 that is interposed between the thin film transistor array panel 100 and the common electrode panel 200. Liquid crystal layer 3 includes liquid crystal molecules which may be oriented perpendicular, or parallel, to the surfaces of the display panels 100 and 200.

First, the thin film transistor array panel 100 will be described. A plurality of gate lines 121 and a plurality of storage electrode lines 131 are formed on an insulation substrate 110 made of transparent glass or plastic, for example. The gate lines 121 are used to transmit gate signals, and extend substantially in a horizontal direction. Each of the gate lines 121 includes a plurality of gate electrodes 124 protruding upward, and an end portion 129 having a large area so as to be connected to another layer or an external driving circuit. A gate driving circuit (not shown) for generating gate signals may be mounted on a flexible printed circuit film (not shown) attached on the substrate 110, may be directly mounted on the substrate 110, or may be integrated into the substrate 110. When the gate driving circuit is integrated into the substrate 110, the gate lines 121 may extend so as to be directly connected to the gate driving circuit 110.

The storage electrode lines 131 extend substantially parallel to the gate lines 121. Each storage electrode line 131 is provided between two adjacent gate lines 121, and is closer to the lower one of the two adjacent gate lines 121. The storage electrode line 131 includes a storage electrode 137 extending upward and downward. However, the shape and arrangement of the storage electrode line 131 may be modified in various ways. A predetermined voltage is applied to the storage electrode lines 131.

The gate lines 121 and the storage electrode lines 131 may be made of an aluminum-based metal, such as aluminum (Al) or an aluminum alloy; a silver-based metal, such as silver (Ag) or a silver alloy; a copper-based metal, such as copper (Cu) or a copper alloy; a molybdenum-based metal, such as molybdenum (Mo) or a molybdenum alloy; or a metal such as chromium (Cr), tantalum (Ta), or titanium (Ti). Advantageously, each of the gate lines and storage electrode lines may be formed with a multi-layered structure. An exemplary multi-layered structure can include two conductive layers (not shown), each having different physical properties. In one exemplary embodiment, one conductive layer of a two-layered structure may be made of a low resistivity metal, so as to reduce signal delay or voltage drop. A suitable material for such a first conductive layer can be an aluminum-based metal, a silver-based metal, or a copper-based metal. The second conductive layer of the two-layered structure can be made of a different conductive material, desirably a material having excellent physical, chemical, and electrical contact characteristics with respect to ITO (indium tin oxide) and IZO (indium zinc oxide). A suitable material for such a second conductive layer can be an for example, a molybdenum-based metal, chromium, tantalum, or titanium. A first exemplary multi-layered conductive structure may have a lower layer of chromium and an upper layer of aluminum or aluminum alloy. A second exemplary multi-layered conductive structure may have a lower layer of aluminum or aluminum alloy, and an upper layer of molybdenum or molybdenum alloy. However, the gate lines 121 and the storage electrode lines 131 also may be made of other conductive materials. The side surfaces of the gate lines 121 and the storage electrode lines 131 are inclined with respect to the substrate 110, with an angle of inclination between the side surface and the substrate being in the range of between about 30° to about 80°.

A gate insulating layer 140 made of silicon nitride (SiNx) or silicon oxide (SiOx), for example, is formed on the gate lines 121 and the storage electrode lines 131. A plurality of semiconductor stripes 151 made of hydrogenated amorphous silicon (abbreviated to “a-Si”), or polysilicon, are formed on the gate insulating layer 140. The semiconductor stripes 151 extend substantially in a vertical direction, and include a plurality of projections 154 protruding toward the gate electrodes 124. Each of the semiconductor stripes 151 has an enlarged width in the vicinity of the gate lines 121 and the storage electrode lines 131, so as to cover the gate lines 121 and the storage electrode lines 131.

A plurality of ohmic contact stripes 161 and ohmic contact islands 165 are formed on the semiconductor stripes 151. The ohmic contact stripes 161 and ohmic contact islands 165 may be made of silicide, or of n+-hydrogenated amorphous silicon in which n-type impurities such as phosphorus are doped at a high concentration. The ohmic contact stripes 161 include a plurality of protrusions 163. The protrusions 163 and the ohmic contact islands 165 are provided in pairs on the projections 154 of the semiconductor stripes 151.

The side surfaces of the semiconductor stripes 151, the ohmic contact stripes 161, and the ohmic contact islands 165 are inclined with respect to the substrate 110, with an angle of inclination between the side surface and the substrate 110 being in the range of between about 30° to about 80°.

A plurality of data lines 171 and a plurality of drain electrodes 175 are formed on the ohmic contact stripes 161, the ohmic contact islands 165, and the gate insulating layer 140. The data lines 171 are used to transmit data signals, and extend substantially in a vertical direction, so as to intersect the gate lines 121 and the storage electrode lines 131. Each of the data lines 171 includes a plurality of source electrodes 173 extending toward the gate electrodes 124, and an end portion 179. The end portion 179 has a large area formed to be connected to another layer or to an external driving circuit. A data driving circuit (not shown) for generating data signals may be mounted on a flexible printed circuit film (not shown) attached on the substrate 110, may be directly mounted on the substrate 110, or may be integrated into the substrate 110. When the data driving circuit is integrated into the substrate 110, the data lines 171 may extend to directly connect to the data driving circuit.

The source electrodes 173 are provided as arcuate projections extending from the data lines 171. The drain electrodes 175 are set apart from, and face, the source electrodes 173, and are separated from the data lines 171. Each of the drain electrodes 175, includes an enlarged width end and a bar shape end portion. The enlarged width end portion the overlaps the storage electrode 137, and the bar shape end portion is partially surrounded by the arcuate projections of source electrodes 173. A portion of drain electrodes 175 and a portion of source electrodes 173 are formed overlappingly on the gate electrodes 124. A gate electrode 124, a source electrode 173, a drain electrode 175, and a projection 154 of the semiconductor stripes 151 form a thin film transistor (TFT), and a channel of the TFT is provided to the projection 154 between the source electrode 173 and the drain electrode 175.

The data line 171 and the drain electrode 175 may be made of a refractory metal including without limitation, molybdenum, chromium, tantalum, titanium, or an alloy thereof. In addition to being formed as single layer structures, the data line 171 and the drain electrode 175 may be formed as a multi-layered structure, including, for example, a refractory metal layer (not shown) and a low-resistance conductive layer (not shown). An exemplary two-layer structure can have a lower layer made of chromium, molybdenum, or a molybdenum alloy; and an upper layer made of aluminum or an aluminum alloy. Similarly, an exemplary three-layer structure can have a lower layer and an upper layer, each made of molybdenum or an molybdenum alloy, with an intermediate layer made of aluminum or an aluminum alloy interposed therebetween. However, the compositions of data lines 171 and the drain electrodes 175 are not confined to the foregoing, and may be made of other suitable metallic materials or conductors.

The side surfaces of the data lines 171 and the drain electrodes 175 are inclined with respect to the substrate 110, with an angle of inclination between the side surface and the substrate being in the range of between about 30° to about 80°.

The ohmic contact stripes 161 and the ohmic contact islands 165 are provided only between the semiconductor stripes 151, and the data lines 171 and the drain electrodes 175. In addition, the ohmic contact stripes 161 and the ohmic contact islands 165 lower the contact resistance between the semiconductor stripes, and the data lines and the drain electrodes. The semiconductor stripes 151 are narrower than the data lines 171 at many positions. However, as described above, the semiconductor stripes 151 have enlarged widths at the intersections with the gate lines 121, to provide a smooth surface profile, thereby minimizing the disconnection of the data lines 171. Portions of the semiconductor stripes 151 are not covered by the data lines 171 and the drain electrodes 175, and are exposed, as are portions between the source electrodes 173 and the drain electrodes 175.

A passivation layer 180 is formed on the data lines 171, the drain electrodes 175, and the portions of the exposed semiconductor stripes 151. The passivation layer 180 includes a lower layer 180p made of an inorganic insulating material, such as silicon nitride or silicon oxide, and an upper layer 180q made of an organic insulating material. The upper passivation layer 180q may have a dielectric constant of about 4.0 or less. In addition, it may have photosensitivity, and can have protrusions and depressions thereon. However, the passivation layer 180 also may have a single-layer structure made of an inorganic insulating material or an organic insulating material. Further, the upper passivation layer 180q can be removed at the end portion 129 of the gate line 121 and at the end portion 179 of the data line 171, if desired to reduce a difference in height.

The passivation layer 180 includes a plurality of contact holes 182 and 185 that expose the end portion 179 of the data line 171 and the drain electrode 175, respectively. In addition, each of the passivation layer 180 and the gate insulating layer 140 includes a plurality of contact holes 181 that expose the end portion 129 of the gate line 121. A plurality of pixel electrodes 191 and a plurality of contact assistants 81 and 82 are formed on the passivation layer 180.

Each of the pixel electrodes 191 is embossed so as to correspond to the protrusions and depressions of the upper passivation layer 180q, and includes a transparent electrode 192, and a reflecting electrode 194 on the transparent electrode 192. The transparent electrode 192 is made of a transparent conductive material, such as ITO or IZO, and the reflecting electrode 194 is made of a reflective metallic material, including, without limitation, aluminum, silver, chromium, or an alloy thereof. The reflecting layer 194 may be a single-layered structure or a multi-layered structure. For example, the reflecting electrode 194 may have a two-layer structure that includes an upper layer (not shown) and a lower layer (not shown). The upper layer is formed of a low-resistance and reflective material, including, without limitation, aluminum, silver, or an alloy of aluminum or silver. The lower layer is formed of a molybdenum-based metal, chromium, tantalum, titanium, or other material exhibiting an excellent contact characteristic with ITO or IZO.

Because the reflecting electrode 194 is provided on a portion of the transparent electrode 192, the transparent electrode 192 is partially exposed. Advantageously, the exposed portion of the transparent electrode 192 is disposed at an opening 195 in the reflecting electrode 194.

The pixel electrodes 191 are physically and electrically connected to the drain electrodes 175 through the contact holes 185, with data voltages being applied to the pixel electrodes 191 from the drain electrodes 175. Data voltages are applied to the pixel electrodes 191, and a common voltage is applied to the common electrode 270 of the common electrode panel 200, generating an electric field across the liquid crystal layer 3 that is interposed between the electrodes 191 and 270. This electric field determines the alignment direction of the liquid crystal molecules of the liquid crystal layer 3 and, thus, controls the polarization of light passing through the liquid crystal layer 3. The pixel electrode 191 and the common electrode 270 form a capacitor (hereinafter, referred to as a “liquid crystal capacitor”) that can maintain an applied voltage even after the thin film transistor is turned off.

Beneficially, a transflective liquid crystal display may include a transmissive area TA defined by the transparent electrode 192 and a reflective area RA defined by the reflecting electrode 194. In the thin film transistor array panel 100, the common electrode panel 200, and the liquid crystal layer 3, a portion below the exposed portion of the transparent electrode 192 serves as the transmissive area TA, and a portion below the reflecting electrode 194 serves as the reflective area RA. In the transmissive area TA, light from the rear surface of the liquid crystal display, that is, from the thin film transistor array panel 100, passes through the liquid crystal layer 3 and travels to the front surface thereof, that is, the common electrode panel 200, thereby generating a display. In the reflective area RA, light from the front surface travels to the liquid crystal layer 3, and is then reflected by the reflecting electrode 194. Thereafter, the light passes through the liquid crystal layer 3 again and travels to the front surface, thereby generating a display. In the latter case, the embossed surface of the reflecting electrode 194 causes light to be reflected and dispersed.

The pixel electrode 191 and the expanding portion 177 of the drain electrode 175, which is connected to the pixel electrode 191, overlap the storage electrode 137 and the storage electrode line 131. The drain electrode 175 is electrically connected to the pixel electrode 191, with an overlap forming a capacitor with the storage electrode line 131. The capacitor is referred to as a storage capacitor, and the storage capacitor improves the voltage holding performance of the liquid crystal capacitor.

The contact assistant 81 is connected to the end portion 129 of the gate line 121 through the contact hole 181; and the contact assistant 82 is connected at the end portion 179 of the data line 171 through the contact hole 182. The contact assistants 81 and 82 improve the adhesive property between an external device and the end portion 129 of the gate line 121, and the end portion 179 of the data line 171. Further, the contact assistants 81 and 82 protect the end portion 129 of the gate line 121 and the end portion 179 of the data line 171, respectively.

In color filter array panel 200, a light blocking member 220 is formed on an insulation substrate 210 made of, for example, transparent glass or plastic. The light blocking member 220, also called a black matrix, defines a plurality of opening regions facing the pixel electrodes 191, and prevents light from leaking between the pixel electrodes 191. In addition, a plurality of color filters 230 are formed on the substrate 210 such that almost all the color filters are disposed in the opening regions surrounded by the light blocking member 220. The color filters 230 are arrayed in strip shapes along the pixel electrodes 191 in a vertical direction. Each of the color filters 230 can display one of the three primary colors of red, green, and blue. Each of the color filters 230 includes a first color filter 231, and a second color filter 233 that is formed on a predetermined region of the first color filter 231. The predetermined region of the first color filter 231 is a region corresponding to the transmissive area TA.

Desirably, the color pigment concentration in the first color filter 231 is lower than the color pigment concentration in the second color filter 233. Accordingly, the color purity of light passing through the second color filter 233 is higher than that of light passing through the first color filter 231.

As described above, when the color pigment concentration contained in the color filter in the transmissive area TA is different from the color pigment concentration in the reflective area RA, a color tone displayed in the transmissive area TA can be made comparable to that displayed in the reflective area RA. That is, when the color filters having the same structure are formed in the transmissive area TA and the reflective area RA, a light path in the reflective area RA is two times longer than a light path in the transmissive area TA. For this reason, the color tone displayed in the transmissive area TA is different from that displayed in the reflective area RA. Such an effect may be undesirable. However, when the dual color filters are used as described herein, light passes two times through a color filter having low color purity in the reflective area RA, and passes one time through a color filter having high color purity and a color filter having low color purity in the transmissive area TA. Accordingly, the color tone displayed in the transmissive area TA can be made comparable to that displayed in the reflective area RA. Advantageously, the thicknesses and the pigment concentrations of each of the color filter having high color purity and the color filter having low color purity can be adjusted so that the color tone displayed in the transmissive area TA can be made comparable to that displayed in the reflective area RA.

An overcoat 250 is formed on the color filter 230 and the light blocking member 220. The overcoat 250 may be made of an organic insulating material. The overcoat 250 protects the color filter 230, prevents the color filter 230 from being exposed, and provides a flat surface. The common electrode 270 is formed on the overcoat 250. The common electrode 270 may be made of a transparent conductive material, such as ITO or IZO. Alignment layers 11 and 21 for orienting the liquid crystal layer 3 are formed on the inner surfaces of the display panels 100 and 200.

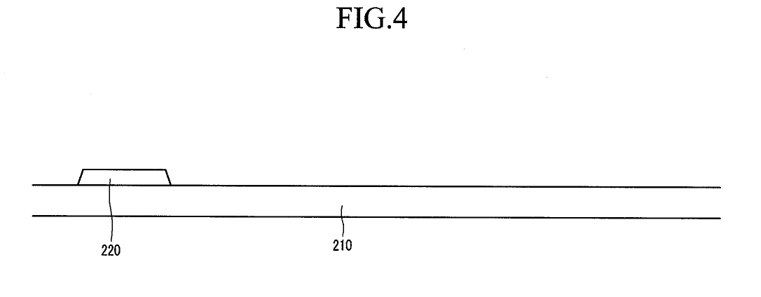

Hereinafter, a method of manufacturing the color filter array panel of the liquid crystal display shown in FIGS. 1 and 2 will be described with reference to FIGS. 4 to 7. FIGS. 4 to 7 are cross-sectional views illustrating a method of manufacturing a color filter array panel according to an exemplary embodiment of the present invention.

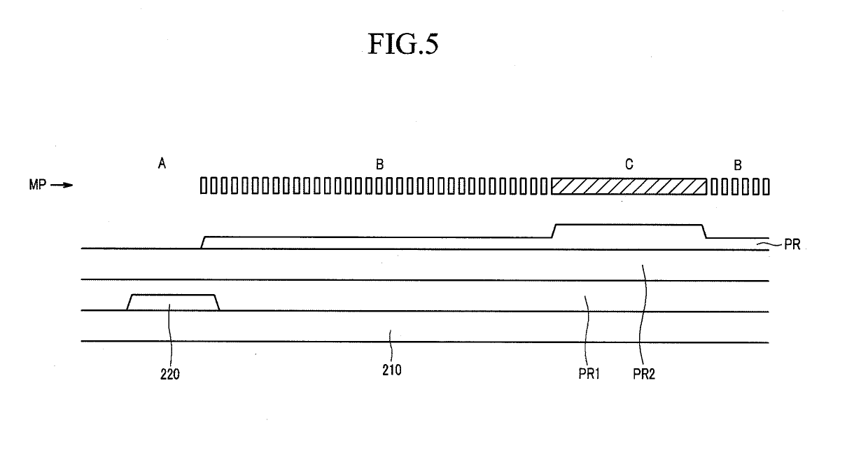

First, as shown in FIG. 4, a photosensitive resin containing black pigment is applied on the substrate 210, and is then patterned to form the light blocking member 220. Subsequently, as shown in FIG. 5, a first photosensitive film PR1 is formed of a low-purity photosensitive material containing a concentration of about 7% red color pigment. Further, a second photosensitive film PR2 is formed on the first photosensitive film PR1. The second photosensitive film PR2 is made of a high-purity photosensitive material containing a greater concentration of red color pigment than the first photosensitive film PR1. In this exemplary embodiment, the second photosensitive film PR2 contains a concentration of about 50% red pigment. Subsequently, the photosensitive films PR are exposed using a photomask that includes three portions A, B, and C, each having different light transmittances.

A method of forming a translucent area B on a photomask, in addition to forming a light transmissive area A, and forming a light blocking area C, is used as a method of manufacturing a photomask including three portions having different light transmittances. For example, a thin film that has a slit pattern, a lattice pattern, or intermediate transmittance and intermediate thickness with respect to a light blocking layer of the light blocking area C, can be formed in the translucent region B. When a slit pattern is used, the width of the slit, or similarly, the gap between the slits, may be smaller than the resolution of a light exposer used in the photolithography process. In an exemplary embodiment of the present invention, the translucent region B is provided in the reflective area RA.

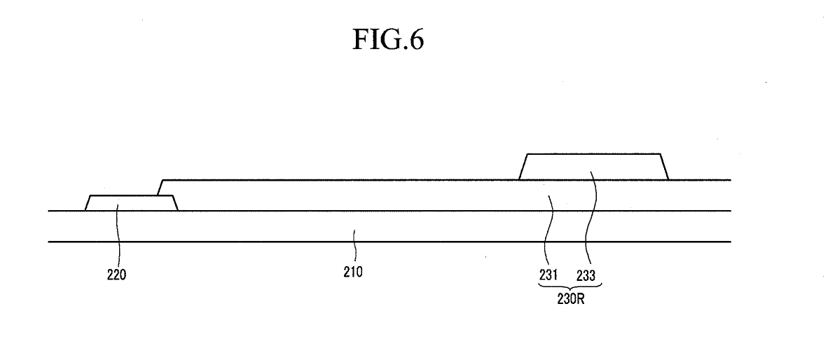

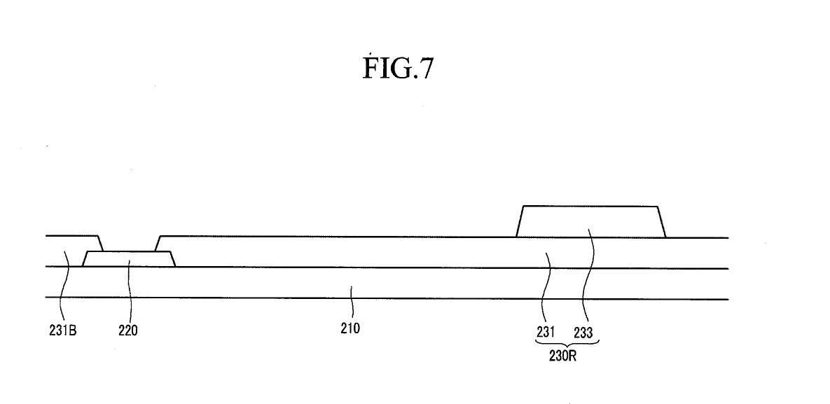

Next, as shown in FIG. 6, the exposed photosensitive film is developed to complete a red filter 230R, including a first red filter 231 and a second red filter 233. Subsequently, as shown in FIG. 7, a blue filter 230B and a green filter (not shown) are formed using the same method as that for forming the red filter 230R. Other suitable and known procedures may be employed.

Next, as shown in FIGS. 1 and 2, an organic material is applied on the substrate 210 to form the overcoat 250, and ITO or IZO is deposited thereon using a sputtering method to form the common electrode 270. Subsequently, processes for forming a column spacer (not shown) and an alignment layer (not shown) on the common electrode 270 are performed.

As described above, the low-purity photosensitive film, and the high-purity photosensitive film are laminated, and then are exposed and developed. Further, it is possible to form a color filter using one exposure process and one developing process, thereby simplify the process of forming the photosensitive films, as compared to a more complex forming process, in which the low-purity photosensitive film and the high-purity photosensitive film are separately formed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of manufacturing a color filter array panel, comprising:
forming a first photosensitive film on an insulation substrate, wherein the first photosensitive film has a first color pigment concentration;
forming a second photosensitive film on the first photosensitive film, wherein the second photosensitive film has a second color pigment concentration, and wherein the second color pigment concentration is greater than the first color pigment concentration;
exposing and developing the first and second photosensitive films to form a first color filter and
a second color filter exposing a predetermined region of the first color filter.

2. The method of claim 1, wherein the first and second photosensitive films are exposed simultaneously using a photomask that includes three portions A, B, and C, having different light transmittances in the exposing of the first and second photosensitive films.

3. The method of claim 2, wherein the photomask includes a light transmissive area, a light blocking area, and a translucent area, wherein the translucent area includes a thin film having one of a slit pattern, a lattice pattern, an intermediate transmittance, or an intermediate thickness.

4. A liquid crystal display comprising:
a first substrate;
pixel electrodes formed on the first substrate, wherein each of the pixel electrodes has a reflecting electrode and a transparent electrode;
a second substrate that faces the first substrate;
a first color filter formed on the second substrate;
a second color filter that is partially formed on a predetermined region of the first color filter;
a common electrode that is formed on the first and second color filters, wherein the common electrode faces the pixel electrodes; and
a liquid crystal layer that is interposed between the common electrode and the pixel electrodes.

5. The liquid crystal display of claim 4, wherein
the first color filter is disposed at a position corresponding to the reflecting electrode and the transparent electrode, and
the second color filter is disposed at a position corresponding to the transparent electrode.

6. The liquid crystal display of claim 5, wherein the second color filter contains a second color pigment concentration that is greater than a first color pigment concentration contained in the first color filter.

7. The liquid crystal display of claim 5, further comprising an overcoat that is formed between the common electrode, and the first and second color filters.
